(19) United States
(12) Patent Application Publication
(10) Pub. No.: US 2014/0087616 A1
(43) Pub. Date: Mar. 27, 2014

(54) Flexible Composite Systems

(71) Applicants: Christopher Michael Adams, Mesa, AZ (US); Wesley Edward Hatcher, Mesa, AZ (US); Keith Joel McDaniels, Mesa, AZ (US)

(72) Inventors: Christopher Michael Adams, Mesa, AZ (US); Wesley Edward Hatcher, Mesa, AZ (US); Keith Joel McDaniels, Mesa, AZ (US)

(21) Appl. No.: 14/031,040

(22) Filed: Sep. 18, 2013

Related U.S. Application Data
(60) Provisional application No. 61/702,702, filed on Sep. 18, 2012.

(51) Int. Cl. C09J 7/04

(52) U.S. Cl. CPC C09J 7/04
USPC 442/149

(57) ABSTRACT

A system for providing improved flexible-composite materials, equipment, and manufacturing processes including improved flexible composite materials is disclosed. In various embodiments, a method of manufacturing a flexible laminate composite can comprise performing surface-energy modification on a low-surface-energy fabric, and coating the low-surface-energy fabric with an adhesive. The method can further include at least partially curing the adhesive to the low-surface-energy fabric. The at least partially curing may use at least one of heated rolls, ovens, vacuum ovens, using light, infrared, autoclaving, or ultraviolet curing. Moreover, the method can produce a flexible laminate composite that is fully or substantially impregnated with adhesive material. A flexible laminate composite can comprise a low-surface-energy fabric subjected to a surface-energy modification, and an adhesive material impregnated within the low-surface-energy fabric. The low-surface-energy fabric can be a polyethylene material, which may or may not be a woven fabric.

### CROSS-REFERENCE TO RELATED APPLICATION

This is a non-provisional application claiming priority to U.S. Provisional App. No. 61/702,702, entitled “FLEXIBLE COMPOSITE SYSTEMS,” filed Sep. 18, 2012, which is hereby incorporated by reference for any purpose in its entirety.

### BACKGROUND

This invention relates to improved flexible composite systems. More particularly this invention relates to a system for providing improved flexible-composite materials, equipment, and manufacturing processes. Flexible-composite materials are widely used in applications requiring both mechanical flexibility and high strength-to-weight ratios. Although flexible-composite materials may be considered a specialized subset of the larger body composite-materials, their importance in many specific areas of technology is significant. As the term suggests, composite materials combine two or more constituent materials to form a unified material composition. An example of a flexible composite material would be a polymer matrix embedding an arrangement of flexible fibers. Utilization of flexible-composite materials is envisioned in many technical fields ranging from simple consumer products to advanced aerospace applications. A system for quickly and economically producing high-quality flexible-composite materials would be of benefit to many.

### SUMMARY

In accordance with various embodiments, an efficient, inexpensive, and useful system utilizing essentially one or more continuous “roll-to-roll” production processes to produce flexible laminate composite material is disclosed herein. A flexible laminate composite can comprise a low-surface-energy fabric subjected to a surface-energy modification, and an adhesive material impregnated within the low-surface-energy fabric. The low-surface-energy fabric can be a polyethylene material, which may or may not be a woven fabric. In various embodiments, the flexible laminate composite can be at least partially cured by an autoclave process.

Further, in various embodiments, a method of manufacturing a flexible laminate composite can comprise performing surface-energy modification on a low-surface-energy fabric, and coating the low-surface-energy fabric with an adhesive. The method can further include at least partially curing the adhesive to the low-surface-energy fabric. The at least partially curing may use at least one of heated rolls, ovens, vacuum ovens, using light, infrared, autoclaving, or ultraviolet curing. Moreover, the method can produce a flexible laminate composite that is fully or substantially impregnated with adhesive material.

### BRIEF DESCRIPTION OF THE DRAWINGS

The features and advantages of the present disclosure will become more apparent from the detailed description set forth below when taken in conjunction with the drawings.

FIG. 1 shows a partial perspective view diagrammatically illustrating a product of an exemplary process used to impregnate at least one fabric to form at least one flexible composite material, in accordance with various embodiments;

FIG. 2 shows a perspective system view of adhesive being applied to a substrate material, in accordance with various embodiments;

FIG. 3 shows a sectional view of a fabric substrate having overlapping adhesive sheets on both sides, in accordance with various embodiments; and

FIG. 4 shows a sectional view of a fabric substrate having continuous adhesive sheets on both sides, in accordance with various embodiments.

### BRIEF GLOSSARY OF TERMS USED HEREIN

Adhesive: A curable resin used to combine composite materials.
Anisotropic: Not isotropic; having mechanical and or physical properties which vary with direction at a point in the material.
aerial weight: The weight of fiber per unit area, this is often expressed as grams per square meter (g/m²).
Autoclave: A closed vessel for producing an environment of fluid pressure, with or without heat, to an enclosed object which is undergoing a chemical reaction or other operation.
B-stage: Generally defined herein as an intermediate stage in the reaction of some thermosetting resins. Materials are sometimes pre cure to this stage, called “prepregs”, to facilitate handling and processing prior to final cure.
C-stage: Final stage in the reaction of certain resins in which the material is relatively insoluble and infusible.
Cure: To change the properties of a polymer resin irreversibly by chemical reaction. Cure may be accomplished by addition of curing (cross-linking) agents, with or without catalyst, and with or without heat.
Decitex(DTEX): Unit of the linear density of a continuous filament or yarn, equal to 1/10th of a tex or 9/10th of a denier
Dyneema® Ultra-high-molecular-weight polyethylene fiber by manufactured DSM
Filament: The smallest unit of a fiber-containing material. Filaments usually are of long length and small diameter.
Polymer: An organic material composed of molecules of monomers linked together.
Prepreg: A ready-to-cure sheet or tape material. The resin is partially cured to a B-stage and supplied to a layup step prior to full cure.
Tow: An untwisted bundle of continuous filaments.
UHMWPE: Ultra-high-molecular-weight polyethylene. A type of polyolefin made up of extremely long chains of polyethylene. Trade names include Spectra® and Dyneema®
Unitape Uni-Directional tape (UD tape)—flexible reinforced tapes (also referred to as sheets) having uniformly-dense arrangements of reinforcing fibers in parallel alignment and impregnated with an adhesive resin. UD tapes are typically B-staged and form the basic unit of most CT composite fabrics.

### DETAILED DESCRIPTION

While exemplary embodiments are described herein in sufficient detail to enable those skilled in the art to practice the invention, it should be understood that other embodiments may be realized and that logical material, process order, and mechanical changes may be made without departing from the spirit and scope of the invention. Thus, the following detailed description is presented for purposes of illustration only.

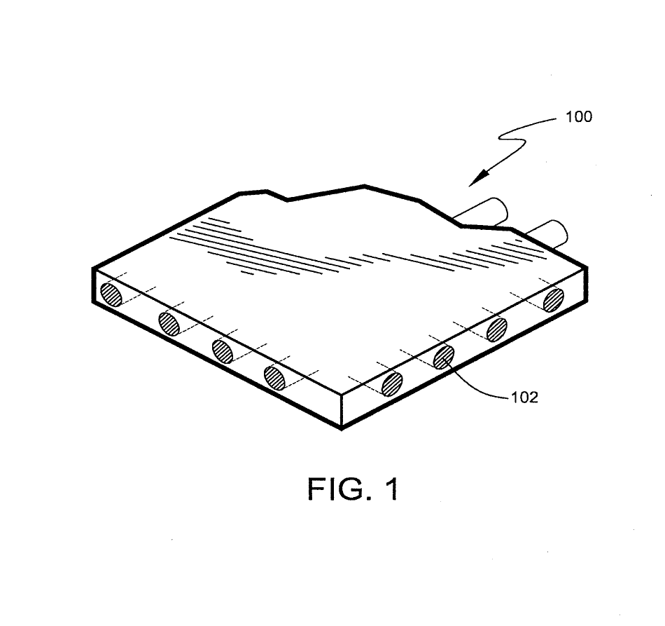

According to preferred embodiments of the present system and with reference to FIG. 1, at least one roll-to-roll coating process is preferably used to impregnate at least one fabric to form at least one flexible-composite material 100. Preferred fabrics usable in the present system preferably include polyethylene, nylon, polyester, UHMWPE (Spectra, Dyneema), para-aramids (Kevlar, Nomex, Technora, Twaron), liquid crystal polymer (Vectran), high tenacity polypropylene, polyimide, other synthetic polymers (PBO, PBI, PIBT, PBZT, PLA, PPTA), metal fiber, glass fiber or some combination of each.

It should be noted that some low-surface-energy fabrics are processed better with surface-energy, adhesion promotion, or adhesion compatibility modification prior to coating to promote bonding of the coating. The mechanisms for adhesion promotion surface cleaning to remove oils, protective sizing's from weaving or processing, or other coating or contaminants, surface oxidation of the fiber surface, micro-etching of the fiber surface, functionalization of the fiber surface by chemical treatment via chemical bath, direct coating, atmospheric or vacuum deposition, application to the outer fiber surface of an organic or inorganic tie layer or coupling agent via chemical bath, direct coating, atmospheric or vacuum deposition, application of functionalized or non-functionalized nano-fiber, nano-particle or nano-film such as grapheme film via chemical bath, direct coating, chemical gas phase treatment, atmospheric or vacuum deposition.

Preferred surface treatment (or pre-treatment) methods include flame treatment, corona, vacuum plasma etching, surface treatment or deposition, atmospheric plasma etching, surface treatment, or disposition, and/or chemical treatment processes, or direct surface coating via dip tank for immersion coating, slot die, reverse roll, gravure, anilox, knife over roll, curtain coating, gap die coating, direct coating via extrusion or co extrusion, air knife, screen, dot matrix or other printing operations, or various atmospheric or vacuum deposition process or any combination thereof. Subsequent polymer coating processes can include curtain coating, gap die coating, gravure coating, immersion coating, knife-over-roll coating, metered rod coating, reverse roll coating, roller coating, extrusion coating, spray coating, autoclaving, or any combination thereof.

Methods to partially or completely consolidate or cure the above-noted coating preferably include heated rolls, ovens, belt presses, vacuum ovens, or using visible light, infrared, radio frequency, e-beam, ambient conditions, ultraviolet (UV) curing, or any combination thereof. In one preferred embodiment of the present system, a low temperature curing adhesive is used because the selected fabric has an especially temperature sensitive low melting point. UHMWPE fabrics, for example, decompose at temperatures greater than 300° F. and the advised short-term duration temperature limit is 145° C. In another preferred embodiment, a thermoset or partially thermoset adhesive is preferably used because this coating can be more robust and does not degrade with heat and UV exposure as quickly as other adhesives. In another preferred embodiment an elastomeric thermoplastic polymer is preferably used, such as urethane, when subsequent bonding and seaming processes may require a thermoplastic coating. In various embodiments, it can be advantageous to use a partially cross linked polymer in an intermediate state of cure and then fully cure the polymer to the final desired degree of polymerization. If adhesive is only partially cured during coating process, a subsequent curing step is preferably used to fully crosslink or polymerize the product, subsequent preferred curing methods to include heated rolls, ovens, vacuum ovens, using visible light, Infrared, bladder press, ultraviolet curing, or controlled temperate profile autoclaves as discussed herein.

In accordance with various embodiments, roll-to-roll coating process can be followed by autoclave cure process. In another preferred embodiment of the present system, the uncured or partially cured coated fabrics described in the previous embodiments proceed to an autoclave curing process. Preferably, the uncured or partially cured coated fabric is placed between layers of release liner (preferably comprising a flouropolymer film or Teflon), next applied are layers of peel ply and breather, and the stack is preferably sealed in a vacuum bag onto a hard caul or rolled configuration. The autoclave preferably uses controlled temperature, pressure, and vacuum to remove entrapped air and volatile components from the coating and flow and consolidate the coating evenly across the surface and through the thickness of the fabric. The resulting coating can be fully or substantially impregnated into the fabric. In various embodiments, the resulting impregnated material can be about 10% to about 70% adhesive by weight. In another embodiment, the resulting impregnated material can be about 25% to about 60% adhesive by weight. In yet another embodiment, the resulting impregnated material can be about 50% adhesive by weight. In various embodiments, it may be desirable to fully impregnate only one side of the fabric and to have the other side unimpregated or partially impregnated. The preferred autoclave process allows for thinner coatings than traditional coating processes because of the even re-flow of adhesive; as a result, lighter weight fabrics are possible.

In accordance with various embodiments, a fiber reinforced adhesive sheet (unitape) or non-fiber reinforced adhesive sheet, can be layered in specific orientations, laminated to a fabric product, and cured in or out of an autoclave. A preferred unidirectional (UD) tape is preferably manufactured by spreading fibers and coating them with an adhesive onto a release paper to form a continuous sheet. This preferred unidirectional tape is nonwoven, although non-impregnated or impregnated unidirectional or multidirectional cloth may also be used. Preferably, these unitape sheets are cut to size and laid down in unidirectional layers in multiple orientations to form a preferred two directional fiber reinforced sheet (examples 0°/90°, +45°/−45°, +30°/−30°), or a preferred four directional non-woven fiber reinforced sheet (preferred examples 0°/90°/45°/−45°, 0°/90°/30°/−30°), or other preferred “custom” oriented non-woven fiber reinforced sheet with many orientations and layer combinations. The unidirectional sheets may be applied to the fabric layer by layer or as a pre-assembled multi-layer sheet of arbitrary length. These non-woven reinforced sheets are preferably laminated to at least one side of the fabric. In another preferred embodiment, the non-woven reinforced sheets are laminated to both sides of the fabric. In another embodiment, the non-woven reinforced sheet is laminated between, or on the outer surfaces of multiple layers of fabrics.

In another embodiment, an unreinforced adhesive sheet tape is produced by coating a release paper with adhesive. The adhesive sheet tape is then applied to the fabric by laying the sheets of adhesive on the fabric and removing the release paper. Multiple overlapping adhesive layers may be added to one or both sides of the fabric.

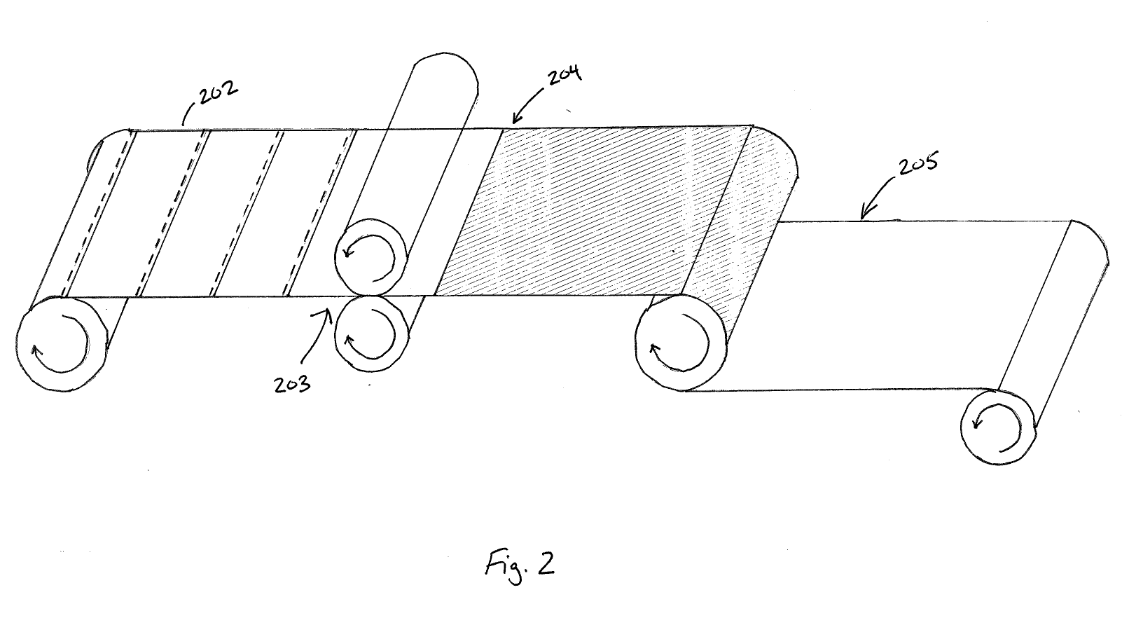

FIG. 2 illustrates an unwinding of a substrate material (the material may be woven or non-woven, treated or not treated) and the addition of adhesive sheets 202 on one surface of the substrate that are slightly overlapped. In various embodiments, the adhesive sheets may not be overlapped, or may have pre-determined gaps between the adhesive sheets. The adhesive sheets can be different shapes or pattern as desired. The adhesive sheets may be pressed onto the substrate with a set of pinch rollers 203, though pinch rollers may not be present in some embodiments and can be substituted with no rollers, or a belt, or the like. Further, after the pinch rollers 203 press the adhesive sheets 202 to the substrate material, the adhesive sheet paper (backing) is removed 204, the adhesive sheet sticks to the substrate. In various embodiments, a release liner 205 is added to the adhesive sheet after the removal of the paper backing so that upon winding the layers don't stick together. In various embodiments, the adhesive sheet can be applied in many ways, for example, both sides of the substrate at the same time in either perpendicular or parallel to the substrate web or one side of the substrate at a time or only ever applied to one side with the other side left bare.

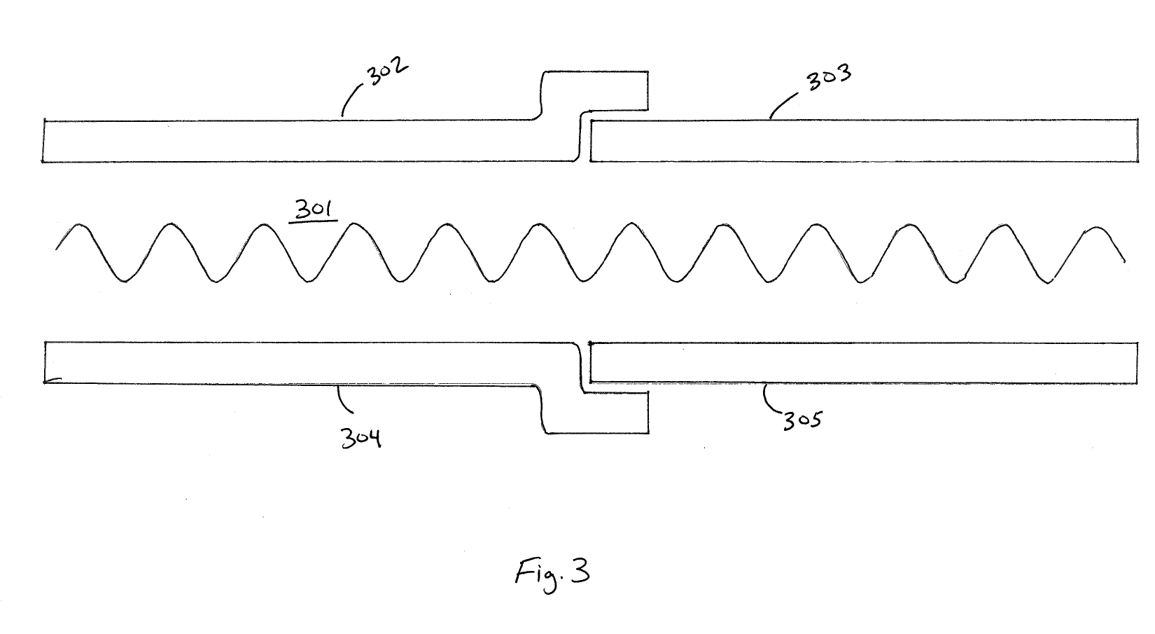

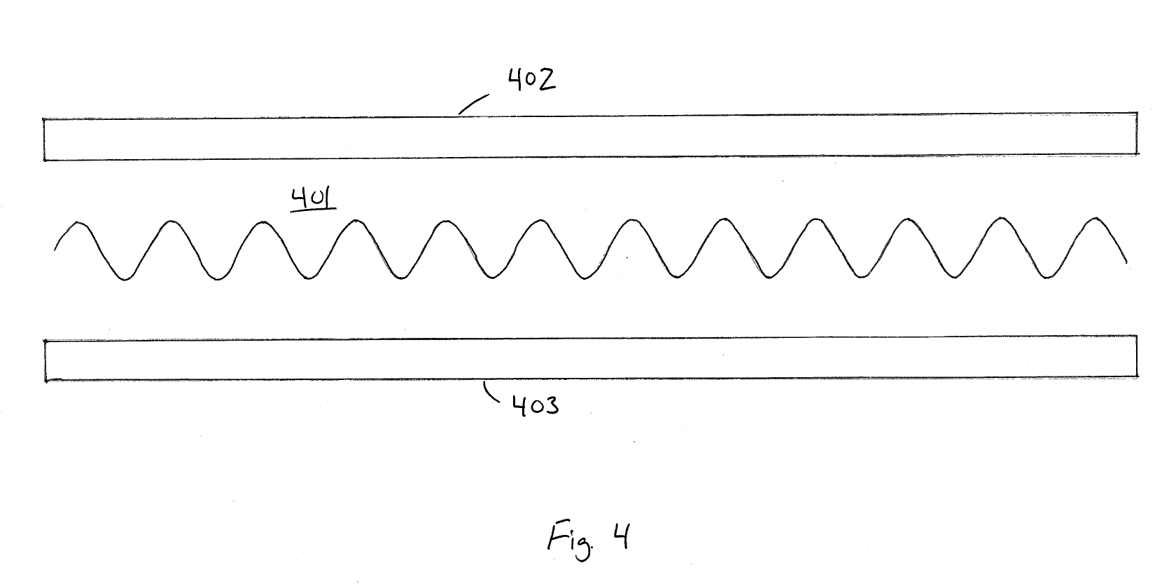

In various embodiments and with reference to FIG. 3, a fabric substrate 301 can have a first adhesive sheet 302 overlapping a second adhesive 303 on a first side of fabric substrate 301. Furthermore, fabric substrate 301 can have a third adhesive sheet 304 overlapping a fourth adhesive sheet 305 on a second side of fabric substrate 301. In other embodiments and with reference to FIG. 4, a fabric substrate 401 can have a first adhesive sheet 402 continuously coated on a first side, and a second adhesive sheet 403 continuously coated on a second side. The resulting coated fabric, with or without additional reinforcement from fiber reinforced unitape layers or non-woven reinforced sheets, can be cured in a roll-to-roll process or in an autoclave as previously described.

In accordance with various embodiments, roll-to-roll coating process or autoclave can be used to bond similar or dissimilar fabrics together. Fabrics are preferably coated and two layers or multiple layers of similar or different uncured fabrics or non-wovens are preferably laminated together. Final cure preferably occurs in a roll-to-roll curing method to partially or completely consolidate or cure the above-noted coating preferably include heated nip or calendar rolls or heated rolls of various configurations, ovens, belt presses, vacuum ovens, or using Visible Light, Infrared, Radio Frequency, E-Beam or Ultra Violet energy activated curing systems.

In accordance with various embodiments, plastic film or fabric can be added to one or both sides of the composite. In various embodiments, at least one plastic film such as PET, PEN, Nylon, flouropolymer, urethane, silicone, polypropylene, polyimide or others are laminated to one or both sides of the above-mentioned embodiments or alternately-preferably between layers of the above-mentioned embodiments prior to, or subsequent to, the lamination and curing process. A textured surface may be incorporated into the surface film during curing/lamination, before lamination as a pre-applied pattern or texture, or can be added as a final operation using embossing or other patterning or polishing operations. In another preferred embodiments a non-impregnated fabric is preferably laminated to one or both sides of the previous embodiments or between layers of the above-mentioned embodiments prior to, or subsequent to, the consolidation and curing process.

It is noted that preferred fabrics utilized within the preferred embodiments of the present system include wovens, knits, imaginable square weave, unidirectional and multidirectional stitched/bonded non-wovens, non-woven felts, basket weave, warp knits, fleece, spun bonded non-wovens, randomly oriented non-woven products, oriented non-woven products, and the like.

In accordance with various embodiments, a production method and procedure for manufacturing flexible laminate composite can be as follows:

### 1) Corona Treat Woven UHMWPE Fabric

UHMWPE fibers (trade names Spectra® & Dyneema) can promote adhesion of the coating better with prior surface treatment. Preferably, a woven fabric roll is loaded onto a machine that passes the fabric through a corona treater and the fabric is then re-rolled or directly coated without being rewound. Applicant's preferred corona treater energizes only one side of the fabric so the fabric must be turned over and passed a second time through the corona to treat the opposite side. Other preferred treater methods surface modify and/or energize both surfaces in a single pass. A run speed of about 10 ft/min and corona energy level of about 1 kW are Applicant's preferred machine settings.

### 2) Manufacture Precursor Sheet Adhesive

The coating for this application is a preferred proprietary partially thermosetting polymer that has excellent adhesion to low surface energy fibers and films and forms a toughened finished product once cured that is puncture resistant and resists UV degradation. Applicant's internal trade name of this coating adhesive is CT71. Pigments, fire retardants, or UV blocking additives are preferably mixed with the adhesive to customize its visual, thermal, electrical, or physical properties. The preferred adhesive is in liquid form and can be pumped onto and extruded between two rollers between top and bottom release papers. Preferably, the top release paper has a lower surface energy than the bottom release paper so that it can be easily removed later in the process leaving the adhesive still stuck to the bottom paper. The preferred adhesive sheet is preferably passed through an oven and a series of heated or cooled rollers to evenly spread and partially cure the adhesive. The preferred adhesive sheet, preferably sandwiched between top and bottom release papers is preferably rolled onto about a 10″ diameter cardboard core at the end of this preferred process. Preferably, the rolls are then bagged and stored to slow down additional curing until lamination may occur. The preferred resulting adhesive sheet is approximate 13.5″ wide. Target adhesive areal weight is preferably between 100 and 125 g/m².

### 3) Lamination/Coating Process

The preferred treated woven UHMWPE fabric is preferably pulled twice through a laminating machine where adhesive sheets are preferably applied first to one side and then to the other side of fabric. The fabric is preferably loaded onto unrolling equipment at the front end of the machine and preferably pulled through to the uptake roll at the back end of the machine. Adhesive sheets are preferably cut from the precursor sheet adhesive roll to the desired length; this length is just shorter than the width of the fabric. The top release paper is preferably peeled from the adhesive sheet leaving the adhesive exposed. Operators preferably place this sheet, adhesive face down onto the fabric. Preferably, the long direction of the adhesive sheet is perpendicular to the lamination machine direction. The adhesive sheets, preferably with bottom release paper still attached, are preferably overlapped about a half-inch so that there are no gaps in the coating. The preferred fabric and adhesive sheets with bottom release paper are preferably passed through a set of heated rollers to bond the adhesive to the fabric. After this set of rollers, operators preferably remove the bottom release paper from the adhesive sheet. Operators preferably cut small pieces of the precursor sheet adhesive roll to create adhesive patches to repair coating gaps or holes in the adhesive coated fabric. At the back end of the machine the material is preferably re-wound preferably with a 0.5 mil ECTFE release liner facing the coating. The internal trade name for this release liner is FC3-0.5. After a length of fabric has been coated on one side, the coated roll is preferably removed from the back of the machine, turned over and preferably re-loaded onto the unrolling equipment on the front of the machine (first remove the uncoated fabric roll). The process is preferably repeated to coat the backside of the fabric. Preferably, a FC3-0.58 release liner is also applied to this side. Alternatively, the adhesive sheet can be applied to the fabric in longitudinal strips that are approximately equal width as the fabric web, narrower than the fabric web or larger than the fabric web. Multiple adhesive sheets can be applied simultaneously in the web direction if the adhesive sheets are narrower than the fabric web. Alternatively, the adhesive sheets can be added to both sides of the fabric in one pass rather than two and may cover the entire fabric area or just a portion of the fabric top and bottom surfaces. Alternatively, sheets of adhesive may be applied to one surface of the fabric in the longitudinal direction of the fabric web while other sheets of adhesive are applied perpendicular to the fabric web direction in either one pass or two passes of the fabric through the laminating machine.

### 4) Cure Process

Preferably, the uncured coated fabric proceeds to an autoclave curing process. An aluminum caul preferably covers the length of a cure table. Next, a layer of peel ply is unrolled, preferably followed by a layer of the uncured coated fabric already sandwiched between FC3-0.5 release film. Preferably, a second layer of peel ply is rolled over the FC3-0.5 and another aluminum caul is placed on top of this layer of peel ply. Multiple layers of caul/peel ply/FC3-0.5/coated fabric/FC3-0.5/peel ply/caul may be stacked. On top of this stack is preferably a thick breather and then preferably a vacuum bag is used to seal the stack. The length of these coated fabric panels may be limited to the length of the cure table. For current embodiments, this length may be about 9 meters. The cure table is preferably pushed into the autoclave. The autoclave preferably uses controlled temperature, pressure, and vacuum to remove entrapped air and volatiles from the coating and flow the coating evenly across the surface and through the thickness of the fabric. Preferably, the resulting coating is fully impregnated into the fabric. The preferred autoclave process allows for thinner coatings than traditional coating processes because of the even re-flow of adhesive; as a result, lighter weight fabrics are possible. It is noted that detailed autoclave process parameters are described in greater detail in Applicant's U.S. Pat. No. 5,470,632 incorporated herein by reference for further examples of implementation engineering. Once the autoclave cure cycle is finished, the cured coated fabric is preferably removed from the autoclave and rolled. It is recommended to leave the release liners on the finished product to prevent the fabric from adhering to itself after storage or shipment.

Preferably, the Composite Material may include coloration of the matrix or membranes through use of pigments or dye sublimation.

Preferably, a fire retardant adhesive or polymer may be used, or fire retardants can be added to a flammable matrix or membrane to improve the flame resistance. Flame retardance or self-extinguishing matrix resins or laminating or bonding adhesives such as Lubrizol 88111 can be used. Either by themselves or in combination with fire retardant additives. Examples of retardant additives include: DOW D.E.R. 593 Brominated Resin, DOW Corning 3 Fire Retardant Resin, and polyurethane resin with Antimony Trioxide (such as EMC-85/10A from PDM Neptec ltd.), although other fire retardant additives may also be suitable. Fire retardant additives that may be used to improve flame resistance include Fyrol FR-2, Fyrol HF-4, Fyrol PNX, Fyrol 6, and SaFRon 7700, although other additives may also be suitable. Fire retardancy and self-extinguishing features can also be added to the fibers either by using fire retardant fibers such as Nomex or Kevlar, ceramic or metallic wire filaments, direct addition of fire retardant compounds to the fiber formulation during the fiber manufacturing process, or by coating the fibers with a sizing, polymer or adhesive incorporating fire retardant compounds listed above or others as appropriate. Any woven materials used in the laminate may be either be pretreated for fire retardancy by the supplier or coated and infused with fire retardant compounds during the manufacturing process.

Preferably, anti-microbial/anti-pathogen resistance may be added to the Composite Material by the incorporation of one or more of anti-microbial agents added or coated onto the polymer resins, or fabrics, and anti-microbial treatments to the fibers, monofilaments, threads or tows used for composite material. Typical materials include OXiTitan Antimicrobial, nano silver compounds, Sodium pyrithione, Zinc pyrithione 2-Fluoroethanol, 1-Bromo-2-fluoroethane, BenzimidaZole, Fleroxacin, 1,4-Butanedisulfonic acid disodium salt, 2-(2-pyridyl)isothiourea N-oxide hydrochloride, Quarternary ammonium salt, 2-Pyridinethiol 1-oxide, Compound Zinc pyrithione, Compound copper pyrithione, magnesium pyrithione, BISPYRITHIONE, pyrithione, ot-Bromo Cinnam-Gel, KFO ABC Silica Gel manufactured. Fiber forms such as threads, tows and monofilaments can be treated with silver nano particles, or can have silver coatings applied via chemical or electrical plating, vacuum deposition or coating with a silver compound containing polymer, adhesive or sizing. The anti-microbial/anti-pathogen materials may also be suitable.

Related disclosures for providing additional information related to coloration of membranes, fire retardant additives, and anti-microbial additives are found in U.S. Pat. No. 5,470,062, entitled “COMPOSITE MATERIAL FOR FABRICATION OF SAILS AND OTHER ARTICLES,” which was issued on Nov. 28, 1995; and U.S. Pat. No. 5,333,568, entitled “MATERIAL FOR THE FABRICATION OF SAILS” which was issued on Aug. 2, 1994; and U.S. patent application Ser. No. 13/168,912, filed Jun. 24, 2011 entitled “WATERPROOF BREATHABLE COMPOSITE MATERIALS FOR FABRICATION OF FLEXIBLE MEMBRANES AND OTHER ARTICLES,”; and U.S. patent application Ser. No. 13/197,741, filed Aug. 3, 2011 entitled “SYSTEM AND METHOD FOR THE TRANSFER OF COLOR AND OTHER PHYSICAL PROPERTIES TO LAMINATE COMPOSITE MATERIALS AND OTHER ARTICLES”, the contents of all of which are hereby incorporated by reference in their entirety.

Although applicant has described applicant's preferred embodiments of this invention, it will be understood that the broadest scope of this invention includes modifications such as diverse shapes (including shapes with single and double complex curvature), sizes, and materials. Such scope is limited only by the below claims as read in connection with the above specification. Further, many other advantages of applicant's invention will be apparent to those skilled in the art from the above descriptions and the below claims.

Benefits, other advantages, and solutions to problems have been described above with regard to specific embodiments. However, the benefits, advantages, solutions to problems, and any element(s) that may cause any benefit, advantage, or solution to occur or become more pronounced are not to be construed as critical, required, or essential features or elements of any or all the claims. As used herein, the terms “includes,” “including,” “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. Further, no element described herein is required for the practice of the invention unless expressly described as “essential” or “critical.”

What is claimed is:

1. A method of manufacturing a flexible laminate composite, the method comprising:
performing surface-energy modification on a low-surface-energy fabric; and
coating the low-surface-energy fabric with an adhesive.

2. The method of claim 1, further comprising at least partially curing the adhesive to the low-surface-energy fabric.

3. The method of claim 2, wherein the at least partially curing uses at least one of heated rolls, ovens, vacuum ovens, using light, infrared, or ultraviolet curing.

4. The method of claim 2, further comprising, in response to the at least partially curing being only a partial cure, subsequently curing the low-surface-energy fabric.

5. The method of claim 4, wherein the subsequently curing uses at least one of heated rolls, ovens, vacuum ovens, using light, infrared, ultraviolet curing, or autoclaving.

6. The method of claim 2, wherein the at least partially curing uses autoclaving.

7. The method of claim 1, wherein the adhesive is fully impregnated into the flexible laminate composite.

8. The method of claim 1, wherein the adhesive is a thermoplastic adhesive, and wherein the flexible laminate composite further comprises bonding and seaming processes using a thermoplastic coating.

9. The method of claim 1, wherein the adhesive is a low temperature curing adhesive, and wherein the low-surface-energy fabric is temperature sensitive.

10. The method of claim 1, wherein the adhesive is at least a partially thermoset adhesive.

11. The method of claim 1, wherein the adhesive is in the form of an adhesive sheet, and wherein the adhesive sheet comprises at least one layer of release paper.

12. The method of claim 1, wherein the low-surface-energy fabric is at least one of nylon, polyester, ultra-high-molecular-weight polyethylene (UHMWPE), para-aramids, liquid crystal polymer, polyimide, a synthetic polymer, metal fiber, glass fiber, and combinations thereof.

13. The method of claim 1, wherein the performing surface-energy modification comprises at least one of flame treatment, corona, plasma, and/or chemical treatment process.

14. The method of claim 1, wherein the coating comprises at least one of curtain coating, gap coating, gravure coating, immersion coating, knife-over-roll coated, metered rod coating, reverse roll coating, roller coating, extrusion coating, spray coating, and autoclaving.

15. A flexible laminate composite prepared by a process comprising the steps of:
performing surface-energy modification on a low-surface-energy fabric; and
coating the low-surface-energy fabric with an adhesive.

16. The flexible laminate composite of claim 15, further comprising the steps of at least partially curing the adhesive to the low-surface-energy fabric.

17. The flexible laminate composite of claim 15, wherein the adhesive is fully impregnated into the flexible laminate composite.

18. A flexible laminate composite comprising:
a low-surface-energy fabric subjected to a surface-energy modification; and
an adhesive material impregnated within the low-surface-energy fabric.

19. The flexible laminate composite of claim 18, wherein the low-surface-energy fabric is a polyethylene material.

20. The flexible laminate composite of claim 18, wherein the polyethylene material is a woven fabric.

21. The flexible laminate composite of claim 18, wherein the polyethylene material is a non-woven fabric.

22. The flexible laminate composite of claim 18, wherein the flexible laminate composite is at least partially cured by an autoclave process.
